(19) United States
(12) Patent Application Publication
(10) Pub. No.: US 2024/0246631 A1
(43) Pub. Date: Jul. 25, 2024

(54) Bicycle Fork And Control Bar Assembly

(71) Applicants: Michael James Clough, Beachwood, OH (US); Michael Joseph Clough, Amherst, NY (US)

(72) Inventors: Michael James Clough, Beachwood, OH (US); Michael Joseph Clough, Amherst, NY (US)

(21) Appl. No.: 18/407,768

(22) Filed: Jan. 9, 2024

Related U.S. Application Data
(60) Provisional application No. 63/439,942, filed on Jan. 19, 2023.
(60) Provisional application No. 63/517,162, filed on Aug. 2, 2023.

(51) Int. Cl. B62K 21/02; B62K 21/04

(52) U.S. Cl. CPC B62K 21/02; B62K 21/04

(57) ABSTRACT

A fork for a cycle comprising a steerer having a first end and a second end, a first and second fork blade, and a crown with two ends. The second end of the steerer attaches to the crown between the two ends of the crown with the steerer extending from the crown to the first end of the steerer. Each fork blade extends from opposite ends of the crown in a direction opposite the second end of the steerer thereby forming a cavity in between the first fork blade and the second fork blade. The first fork blade has a first attachment assembly at a distal end of the first fork blade to attach to a first cycle wheel in the cavity. The second fork blade has a second attachment assembly at a distal end of the second fork blade adapted to attach a second cycle wheel in the cavity.

### RELATED APPLICATIONS

This application claims priority to U.S. Prov. Application Ser. No. 63/439,942 filed on Jan. 19, 2023 and U.S. Prov. Application Ser. No. 63/517,162 filed on Aug. 2, 2023, each of which are expressly incorporated herein by reference.

### BACKGROUND

Bicycles are designed for enjoyment, exercise, and transportation. However, some bicycles do not provide enough stability for bicycle users that are concerned about imbalance or constantly putting his or her feet down. For example, those recovering from injuries, surgeries, joint issues, and people who are simply seeking less risk of falling, often pursue enhanced stability in their bicycles.

There have been some attempts at addressing stability issues within the personal mobility device area. For example, recumbent bicycles and tricycles exist in the market today, but are costly and require the purchase of a new bicycle. Tricycles feature two wheels in the rear of the bike, which requires the modification of the gear system attached to the back tire. Additionally, although tricycles can offer some enhanced stability at slow speeds, tricycles can be less stable at higher speeds and when taking sharp turns.

Some bicycles provide a front fork attachment with two dual-wheel forks. However, two dual-wheel forks have a positive or zero camber, which can create instability. Additionally, a user may be biased against using such a design because social perceptions typically associate these bicycles with riders who are either very young or elderly. Thus, there exists a need to provide a bicycle fork that effectively provides stability and comfort to bicycle users who are unable to ride a traditional bicycle. Accordingly, a stable bicycle platform to achieve agility and steadiness thereby ensuring an enjoyable and dependable ride is desirable.

### BRIEF DESCRIPTION

According to one aspect, a front fork for a cycle includes a steerer having a first end and a second end, a first fork blade and a second fork blade, and a crown. The crown having two ends where the second end of the steerer attached to the crown between the two ends of the crown with the steerer extending from the crown to the first end of the steerer. Each fork blade extends from opposite ends of the crown in a direction opposite the second end of the steerer thereby forming a cavity in between the first fork blade and the second fork blade. The first fork blade has a first attachment assembly at a distal end of the first fork blade to attach to a first cycle wheel in the cavity. The second fork blade has a second attachment assembly at a distal end of the second fork blade adapted to attach a second cycle wheel in the cavity.

According to another aspect, a bicycle includes a bicycle frame configured to couple with a first front bicycle wheel, a second front bicycle wheel, and a rear bicycle wheel. A front fork is coupled to the first front bicycle wheel and the second front bicycle wheel. The front fork including a steerer having a first end and a second end, a first fork blade and a second fork blade, and a crown with two ends. The second end of the steerer attaches to the crown between the two ends of the crown with the steerer extending from the crown to the first end of the steerer. Each fork blade extends from opposite ends of the crown in a direction opposite the second end of the steerer, forming a cavity in between the first fork blade and the second fork blade. The front fork includes a first attachment assembly at a distal end of the first fork blade adapted to attach a first cycle wheel in the cavity. The second fork includes a second attachment assembly at a distal end of the second fork blade adapted to attach a second cycle wheel in the cavity.

### BRIEF DESCRIPTION OF THE DRAWINGS

The accompanying drawings, which are incorporated in and constitute a part of the specification, illustrate various systems, methods, devices, and other embodiments of the disclosure. It will be appreciated that the illustrated element boundaries (e.g., boxes, groups of boxes, directional lines, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 is an elevation view of a bicycle having a front fork according to an exemplary embodiment;

FIG. 2A is an elevation view of the front fork of FIG. 1 according to an exemplary embodiment;

FIG. 2B is a side view of the front fork of FIG. 2A according to an exemplary embodiment;

FIG. 3 is a side view of the bicycle of FIG. 1 according to an exemplary embodiment;

FIG. 4A is a perspective view showing attachment of a first cycle wheel to a first fork blade according to an exemplary embodiment;

FIG. 4B is a perspective view showing attachment a second cycle wheel to a second fork blade according to an exemplary embodiment;

FIG. 5 is a front view of the bicycle of FIG. 1 showing exemplary camber angles according to an exemplary embodiment;

FIG. 6 is an elevation view of a bicycle having a front fork and a control bar assembly according to an exemplary embodiment;

FIG. 7 is an elevation view of the front fork of FIG. 6 according to an exemplary embodiment;

FIG. 8 is a front view of the bicycle of FIG. 6 according to an exemplary embodiment;

FIG. 9 is a detailed view of a joint connecting the control bar assembly to a bike wheel and a disc brake according to one exemplary embodiment; and

FIG. 10 is an elevation view of a bicycle in a cruiser design according to an exemplary embodiment.

### DETAILED DESCRIPTION

The embodiments and systems disclosed herein provide a single bicycle fork with two blades that are individually coupled to a wheel. thereby providing a stable and agile bicycle platform while allowing a rider to feel like they're riding a traditional bike. Additional embodiments incorporate a control bar assembly with the bicycle fork adding additional stability and agility. Throughout this document, bicycle refers to any wheeled mode of transportation that is mechanically powered by a gear and chain.

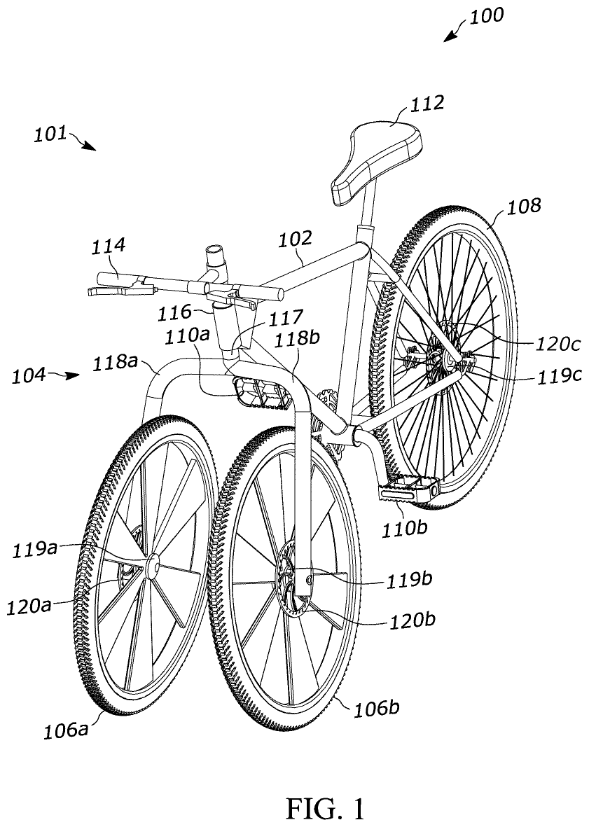

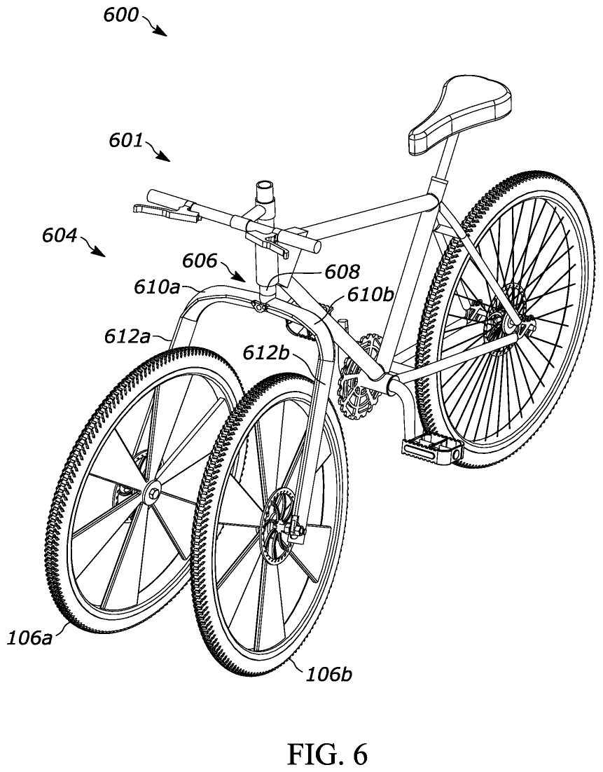

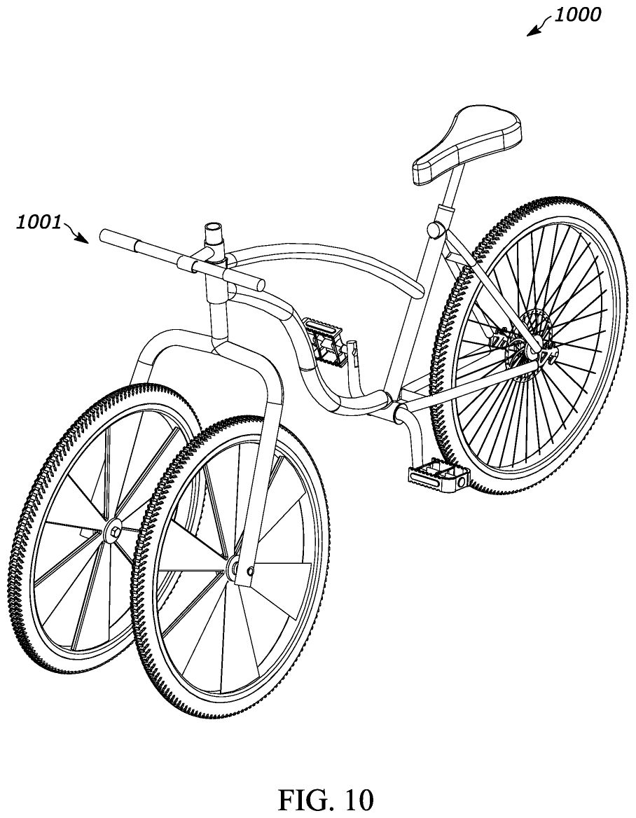

Referring now to the drawings, FIG. 1 is an elevation view 100 of a bicycle, which is indicated generally at 101. The exemplary embodiment of the bicycle 101 shown in FIG. 1 may be referred to herein as a fixed-fork bicycle, components of which will be described with references to FIGS. 1-5. However, it is understood that one or more components of the bicycle 101 may be implemented in other exemplary embodiments, for example, a bicycle including a control bar assembly, which will be discussed in further detail with FIGS. 6-9. The front fork and control bar assembly described herein can also be implemented with different bicycle designs and/or frames, for example, a bicycle 1001 shown in FIG. 10 is a cruiser bicycle design. Accordingly, it is understood that the bicycle 101, the bicycle frame 102, and the other bicycle components discussed herein can include different designs and arrangements other than those shown in FIG. 1.

Referring again to FIG. 1, the bicycle 101 includes a bicycle frame 102 configured to couple with a first front bicycle wheel 106a, a second front bicycle wheel 106b, and a rear bicycle wheel 108. The bicycle frame 102 also includes other bicycle features, such as, but not limited to, a first pedal 110a, a second pedal 110b, a seat 112, handlebars 114, and a head tube 116.

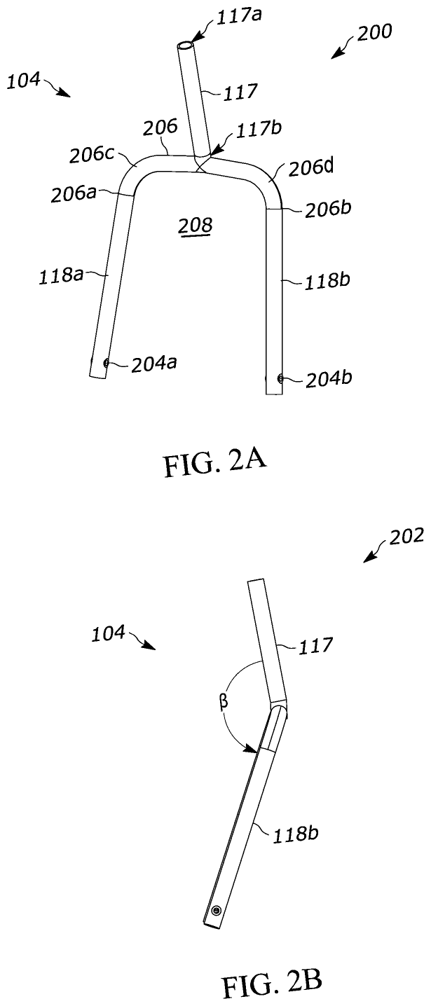

The bicycle 101 also includes a front fork 104 for coupling to the first front bicycle wheel 106a and the second front bicycle wheel 106b. The front fork 104 will now be described in detail, with additional reference to FIG. 2A, which illustrates a perspective view 200 of the front fork 104. As shown, the front fork 104 is a unitary structure and includes a steerer 117, a crown 206, a first fork blade 118a and a second fork blade 118b. In other embodiments, the front fork 104 can have separate members that attach to one another. In some embodiments, the front fork 104 is a hollow member with wall thickness of 0.1 to 0.2 inches. The front fork 104 can have overall dimensions of 27.1 inches long and 15.6 inches wide. The front fork 104 can be wide enough to receive large storage containers, locking devices, lighting fixtures, and other accessories that cannot attach to a narrower fork that couples to one wheel.

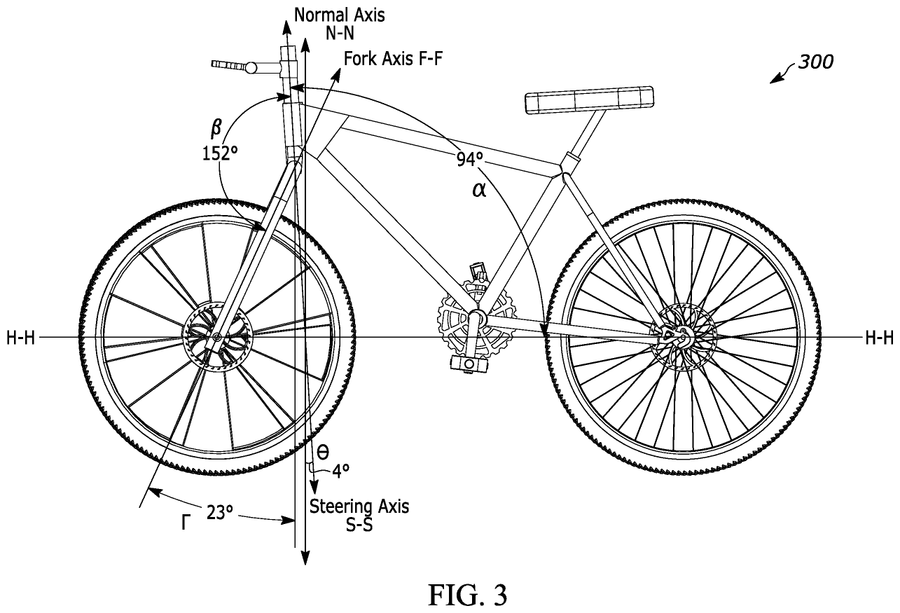

The steerer 117 has a first steerer end 117a and a second steerer end 117b. The crown 206 has a first crown end 206a and a second crown end 206b. The second steerer end 117b attaches to the crown 206 centrally (e.g., at an apex) between the first crown end 206a and the second crown end 206b, and the steerer 117 extends upwards to the first steerer end 117a. The steerer 117 is configured to attach to the bicycle frame 102 via the head tube 116. The length of the steerer 117 can be adjusted to ensure a desired handlebar 114 height. In some embodiments, the length of the steerer is approximately 9.7 inches. As will be discussed in further detail herein, the first steerer end 117a of the steerer 117 and the second steerer end 117b of the steerer 117 have a circular opening with a center point forming a steering axis S-S (see FIGS. 2B, 3). In one exemplary embodiment, the circular opening (i.e., the diameter of the steerer 117) has a diameter of 1.3 inches. It is understood that the diameter of the steerer 117 can be adjusted to fit different types of bicycle frames.

Each fork blade 118a and 118b extends from opposite ends of the crown 206 in a direction opposite the second end of the steerer 117, forming a cavity 208 in between the first fork blade 118a and the second fork blade 118b. Said differently, the first fork blade 118a extends from the first crown end 206a in a direction opposite the second steerer end 117b and the second fork blade 118b extends from the second crown end 206b in a direction opposite the second steerer end 117b. Accordingly, the first fork blade 118a and the second fork blade 118b are parallel to one another.

The first fork blade 118a and the second fork blade 118b are each configured to couple to the first front bicycle wheel 106a and the second front bicycle wheel 106b, respectively. The first fork blade 118a and the second fork blade 118b couple to the two bicycle wheels 106a and 106b from the outer sides of each wheel so that the two front bicycle wheels 106a and 106b are positioned in the cavity 208 between the first fork blade 118a and the second fork blade 118b. For attachment of the wheels to the front fork 104, the front fork 104 includes a first attachment assembly 204a at a distal end of the first fork blade 118a adapted to attach the first front bicycle wheel 106a in the cavity 208. Additionally, the front fork 104 includes a second attachment assembly 204b at a distal end of the second fork blade 118b adapted to attach the second front bicycle wheel 106b in the cavity 208. The wheel attachments also each include a front bicycle wheel hub, namely, a first front wheel hub 119a and a second front wheel hub 119b, each having respective disc brakes, namely, a first front wheel disc brake 120a and a second front wheel disc brake 120b. The rear bicycle wheel 108 also includes a rear wheel hub 119c and a rear wheel disc brake 120c.

In one embodiment, the thickness of the first fork blade 118a and the second fork blade 118b tapers from the crown 206 to the distal ends of the first fork blade 118a and the second fork blade 118b (i.e., towards the attachment assemblies 204a, 204b). The front fork 104 is the thickest along the crown 206 and the thickness starts to taper at each bend 206c and 206d of the crown 206. The thickness of front fork 104 continues to taper so the first fork blade 118a and the second fork blade 118b are the thinnest at the attachment assembly of each blade. The preferred thickness ranges from 1.75 to 1.25 inches. This ensures the front fork 104 can withstand the greater bending and moment stresses resulting from coupling a wheel to the first fork blade 118a and the second fork blade 118b.

Measurements and angles of the bicycle 101 and the front fork 104 will now be described with respect to FIG. 2B, which illustrates a side perspective view 202 of the front fork 104, and FIG. 3, which illustrates a side view 300 of the bicycle 101. The first steerer end 117a of the steerer 117 and the second steerer end 117b of the steerer 117 have a circular opening with a center point forming a steering axis S-S, where the first fork blade 118a is parallel to the second fork blade 118b creating a fork axis F-F. The steering axis S-S and the fork axis F-F intersect to fork an obtuse angle β. In FIG. 3, the obtuse angle beta β is 152 degrees, however, in other embodiments, the obtuse angle β can range from 150 degrees to 154 degrees. Accordingly, each fork blade is angled approximately 5 degrees from vertical a center line of the long axis of the steerer 117.

A hub axis H-H is shown longitudinally from the second front wheel hub 119b of the second front bicycle wheel 106b to a rear wheel hub 119c of the rear bicycle wheel 108. The hub axis H-H is parallel to a ground surface on which the bicycle 101 is placed upon. A normal axis N-N is defined as being perpendicular to the H-H axis. The normal axis N-N and the steering axis S-S intersect to create an acute angle, theta θ, which lies adjacent to angle beta β. In some embodiments, theta θ ranges from 2-6 degrees. An angle alpha α is formed between the hub axis H-H and the steering axis S-S. The angle alpha α is an obtuse angle and ranges from 92-96 degrees. Finally, angle gamma Γ is created by the fork axis F-F and the normal axis N-N. The angle gamma Γ is an acute angle that ranges from 22-24 degrees.

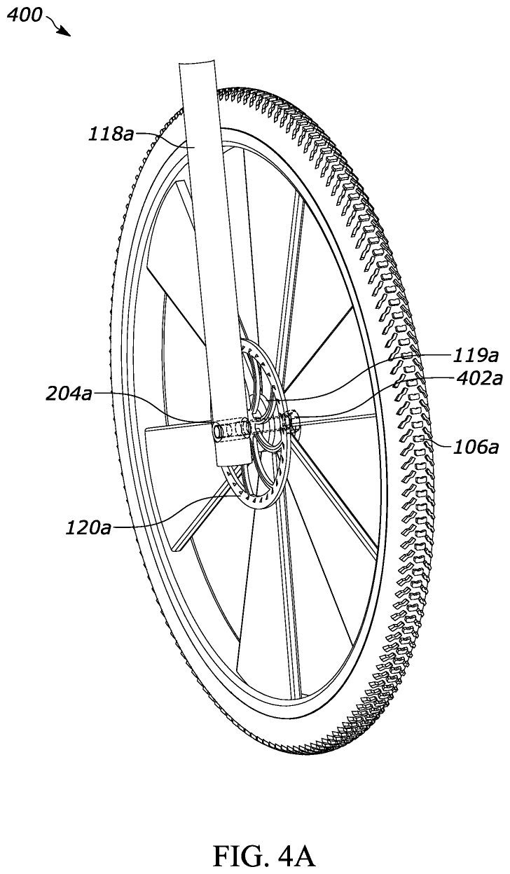

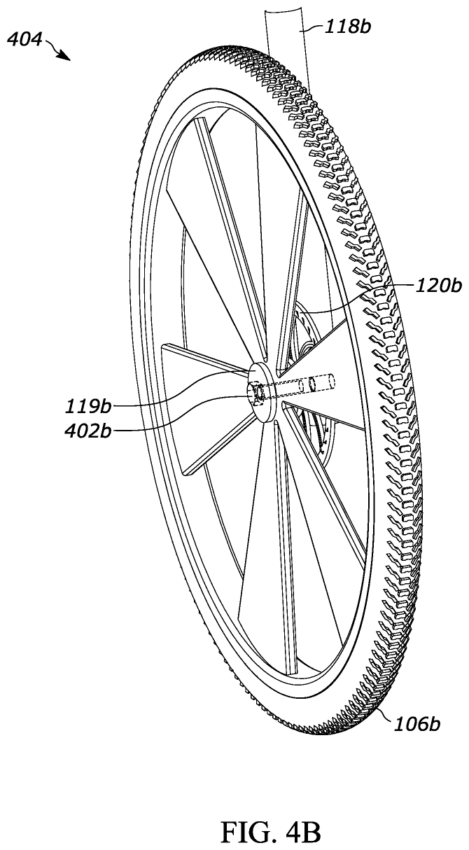

The attachment of the wheel assembly to the front fork 104 will now be described in more detail with FIGS. 4A and 4B. FIG. 4A illustrates a perspective view of the first front bicycle wheel 106a to the first fork blade 118a. Here, the first attachment assembly 204a is a first cylindrical threaded insert for receiving a first bolt 402a to interlock the first front bicycle wheel 106a, including the first front wheel hub 119a and the first front wheel disc brake 120a, with the first fork blade 118a in the cavity 208. Similarly, FIG. 4B illustrates the second attachment assembly 204b as a second cylindrical threaded insert for receiving a second bolt 402b to interlock the second front bicycle wheel 106b, including the second front wheel hub 119b and the second front wheel disc brake 120b, with the second fork blade 118b in the cavity 208.

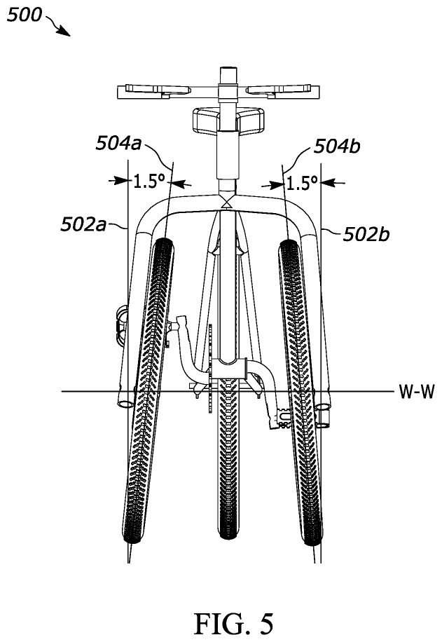

Referring now to FIG. 5, a front view 500 of the front fork 104 is shown when front bicycle wheels 106a and 106b are attached to first fork blade 118a and the second fork blade 118b. A true vertical axis 502a of the first front bicycle wheel 106a is shown perpendicular to a front wheel axis W-W running through the hub of the first front wheel and the hub of the second front wheel. A true vertical axis 502b of the second front bicycle wheel 106b is shown perpendicular to the front wheel axis W-W. A first front wheel centerline 504a and a second front wheel centerline 504b define the camber angle for each wheel. As shown, the wheels have a negative camber when attached to the front fork 104. In other words, the top of the wheels lean inwards towards the center of the bicycle 101 or the steering axis S-S. In this embodiment, the wheels have about a 1.5-degree negative camber. The negative camber provides the two front wheels with great handling and maneuverability for a more user-friendly ride experience. In some instances, greater stability can be provided by modifying the camber angle of the wheels. This can be achieved with a control bar assembly, which will now be discussed in further detail.

### Control Bar Assembly

A control bar assembly can be implemented with the systems described herein to allow front wheels of a bike to have a small range in which the wheels can tilt. In this embodiment, the control bar assembly is attached to the front fork and the front wheels are directed coupled to the control bar assembly. The control bar assembly allows for easier steering and assists in keeping the bike level when riding on uneven surfaces (e.g., bumpy, rough). Additionally, the control bar assembly allows for a less rigid bike fork and thereby provides a smoother riding experience when the bike travels over uneven surfaces.

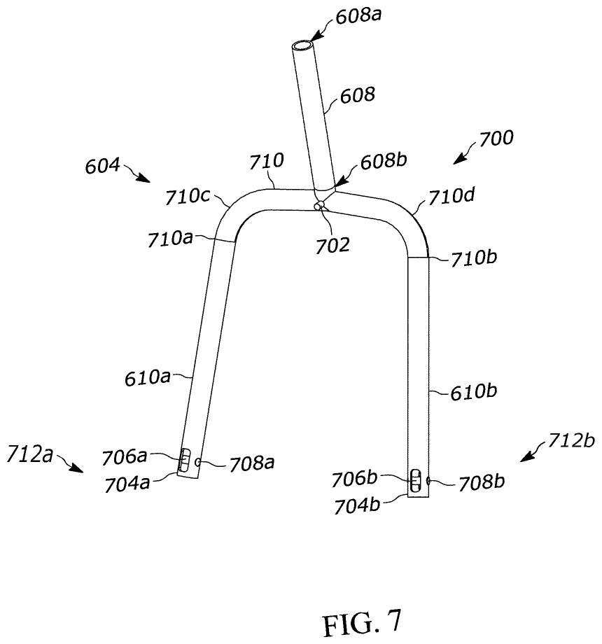

The control bar assembly will now be described in more detail with reference to FIGS. 6-9. It is understood that the control bar assembly and other components of FIGS. 6-9 can be implemented with one or more of the components of the bicycle 101 as shown in FIGS. 1-5. Additionally, it is understood that for simplicity, like numerals represent the same components in different views. FIG. 6 is an elevation view 600 of a bicycle 601 having a front fork 604 and a control bar assembly 606 is shown. For simplicity, only the element numbers relating to the front fork 604 with control bar assembly 606 are shown in FIG. 6, however, the front fork 604 can be implemented with the bicycle 101 and the bicycle frame 102 shown in FIG. 1. FIG. 7 illustrates an elevation view 700 of the front fork 604 of FIG. 6 without the control bar assembly 606 to illustrate how the front fork 604 attaches to the control bar assembly 606. The dimensions and measurements of the front fork 604 are the same as discussed above with the front fork 104 in FIGS. 1-5.

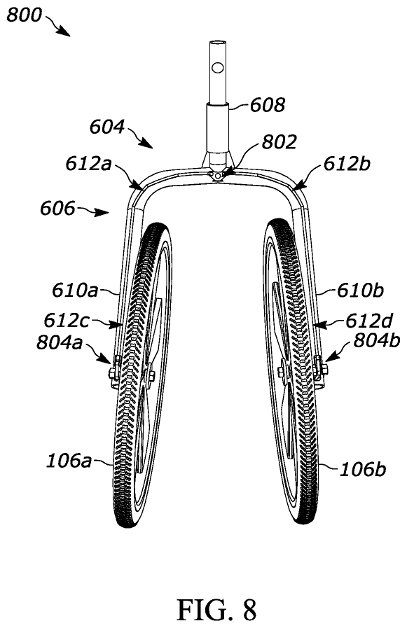

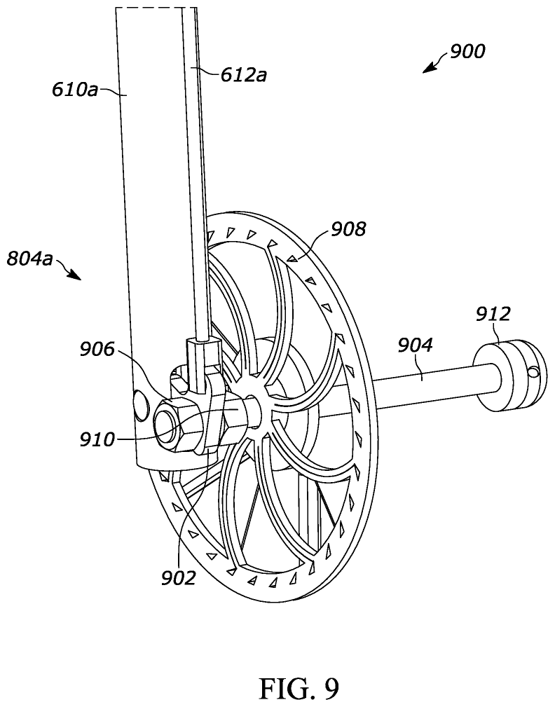

In FIG. 6, the front fork 604 includes a steerer 608, a first fork blade 610a, and a second fork blade 610b having the same and similar characteristics as the front fork components in FIGS. 1-5. The control bar assembly 606 includes a first control bar arm 612a and a second control bar arm 612b, which are centrally (e.g., at an apex of the crown) mounted to a crown 710 of the front fork 604 via a pivot joint assembly 802 coupled to a first end of the first control bar arm 612a and at a first end of the second control bar arm 612b. The control bar assembly 606 is connected at the distal ends of the front fork 604 at the first attachment assembly 712a and the second attachment assembly 712b. The first attachment assembly includes a slot 704a, a bolt 706a, and an opening 708a. The bolt 706a slides in to attach a knuckle joint (FIGS. 8, 9) to the first fork blade 610a. The second attachment assembly 712b includes a slot 704b, a bolt 706b, and an opening 708b. The bolt 706b slides in to attach a knuckle joint (FIG. 8) to the second fork blade 610b.

The first control bar arm 612a extends outwardly left of the front fork 604 and the first attachment assembly 712a is adapted to attach to a second end 612c of the first control bar arm 612a. The second control bar arm 612b extends outwardly right of the front fork and the second attachment assembly 712b is adapted to attach to the second end 612d of the second control bar arm 612b. The distal ends (i.e., the second ends 612c, 612d) of the first control bar arm 612a and the second control bar arm 612b each include a knuckle joint assembly (FIG. 8) for coupling the bicycle wheels to the front fork 604. Said differently, the second end 612c of the first control bar arm 612a is coupled to the first front bicycle wheel 106a and the second end 612d of the second control bar arm 612b is coupled to the second front bicycle wheel 106b.

As shown in FIG. 7, the front fork 604 includes a pin connector 702 for pivotally connecting the control bar assembly 606 to the front fork 604. The pin connector 702 is used to attach the first control bar arm 612a and the second control bar arm 612b to the pivot joint assembly 802 and the front fork 604. Like the front fork 104, the front fork 604 includes a crown 710 having a first end 710a, a second end 710b with the crown 710 including the bends 710c and 710d. The steerer 608 includes a first steerer end 608a and a second steerer end 608b.

The slot cutout allows a knuckle joint to move up and down and attach to a knuckle bolt, which will now be described in more detail with FIGS. 8 and 9. FIG. 8 illustrates a front view 800 of the bicycle 601 of FIG. 6 according to an exemplary embodiment, and FIG. 9 is a detailed view 900 of a knuckle joint assembly connecting the control bar assembly to a bike wheel (not shown for simplicity) and a disc brake according to one exemplary embodiment. As shown, the control bar assembly 606 is connected to the bicycle wheels 106a and 106b via knuckle joint assemblies 804a and 804b. In particular, the first control bar arm 612a connects to the front bicycle wheels 106a via the knuckle joint assembly 804a and the second control bar arm 612b connects to the wheel 106b via the knuckle joint assembly 804b. More specifically, the rim of the front bicycle wheels 106a, 106b include an opening in the center hub for passage and connectivity of the knuckle joints 804a, 804b.

With this configuration, the control bar assembly 606 allows for the two side by side front bicycle wheels 106a, 106b to shift in one direction or another slightly changing the angles (i.e., camber angles) of the wheels, specifically around turns. This improves the stability through a turn and keeps the wheels from lifting off the ground. Thus, movement of the control bar assembly 606 affects a camber angle of the bicycle 601. More specifically, in FIG. 8, the control bar assembly 612 is shown in a neutral position, the wheels having the same camber angle as shown in FIG. 5. During a turn, the control bar assembly 612 will shift thereby changing the camber of the wheels. This will improve stability through the turn and advantageously keep the wheels from lifting off the ground.

Referring now to FIG. 9, the knuckle joint assembly will be described in more detail. For simplicity, the front bicycle wheels 106a, 106b are not shown. Additionally, for simplicity, these figures only show the first knuckle joint assembly 804a. However, it is understood, that the second knuckle joint assembly 804b can include one or more of similar and/or same components. Accordingly, in FIG. 9, the first knuckle joint assembly 804a is shown including a knuckle joint 902, a bolt 904, a locknut 906, a first bearing 910, and a second bearing 912. The locknut 906 keeps the bolt 904 anchored. The bolt 904 goes through a hub of the first front bicycle wheel 106a, for example, via a disc brake 908 and through the center of the wheel hub.

Those of ordinary skill in the art will conceive of other alternate embodiments upon reviewing this disclosure. Thus, the disclosures herein are not to be limited to the above description but is to be determined in scope by the claims which follow.

1. A front fork for a cycle, comprising:
a steerer having a first end and a second end;
a first fork blade and a second fork blade;
a crown with two ends wherein the second end of the steerer attaches to the crown between the two ends of the crown with the steerer extending from the crown to the first end of the steerer, wherein each fork blade extends from opposite ends of the crown in a direction opposite the second end of the steerer thereby forming a cavity in between the first fork blade and the second fork blade;
a first attachment assembly at a distal end of the first fork blade adapted to attach to a first cycle wheel in the cavity; and
a second attachment assembly at a distal end of the second fork blade adapted to attach a second cycle wheel in the cavity.

2. The front fork of claim 1, wherein the steerer, the first and second fork blade, and the crown are a unitary structure.

3. The front fork of claim 1, wherein the first and second fork blades are configured so that the first cycle wheel has a negative camber with the second cycle wheel.

4. The front fork of claim 3, wherein the negative camber is 1.5 degrees.

5. The front fork of claim 1, the first attachment assembly having a first cylindrical threaded insert for receiving a first bolt to interlock the first cycle wheel with the first fork blade in the cavity, and the second attachment assembly having a second cylindrical threaded insert for receiving a second bolt to interlock the second cycle wheel with the second fork blade in the cavity.

6. The front fork of claim 1, wherein the first fork blade and the second fork blade are tapered.

7. The front fork of claim 5, wherein the first and second fork blade have a thickness ranging from 1.25 to 1.75 inches.

8. The front fork of claim 1, wherein the first end of the steerer and the second end of the steerer each have a circular opening with a center point forming a steering axis S-S, wherein the first fork blade is parallel to the second fork blade creating a fork axis F-F, and wherein the steering axis S-S and the fork axis F-F intersect to form an obtuse angle.

9. The front fork of claim 7, wherein the obtuse angle ranges from 150 degrees to 154 degrees.

10. The front fork of claim 1, further comprising a control bar assembly centrally mounted on the front fork and configured to couple to the first cycle wheel and the second cycle wheel, wherein movement of the control bar assembly affects a camber angle of the cycle.

11. The front fork of claim 10, the control bar assembly comprising a first control bar arm and a second control bar arm, wherein a first end of the first control bar arm and a first end of the second control bar arm are pivotally attached centrally to the crown of the front fork.

12. The front fork of claim 11, wherein the first control bar arm extends outwardly left of the front fork and the first attachment assembly is adapted to attach to a second end of the first control bar arm, wherein the second control bar arm extends outwardly right of the front fork and the second attachment assembly is adapted to attach to the second end of the second control bar arm.

13. The front fork of claim 12, wherein the second end of the first control bar arm is coupled to the first cycle wheel and the second end of the second control bar arm is coupled to the second cycle wheel.

14. A bicycle, comprising:
a bicycle frame configured to couple with a first front bicycle wheel, a second front bicycle wheel, and a rear bicycle wheel; and
a front fork coupled to the first front bicycle wheel and the second front bicycle wheel, wherein the front fork includes a steerer having a first end and a second end, a first fork blade and a second fork blade, a crown with two ends wherein the first end of the steerer attaches to the crown between the two ends of the crown with the steerer extending from the crown to the second end of the steerer,
wherein each fork blade extends from opposite ends of the crown in a direction opposite the second end of the steerer, forming a cavity in between the first fork blade and the second fork blade, wherein the front fork includes:
a first attachment assembly at a distal end of the first fork blade adapted to attach a first cycle wheel in the cavity, and
a second attachment assembly at a distal end of the second fork blade adapted to attach a second cycle wheel in the cavity.

15. The bicycle of claim 14, wherein the first and second fork blades are configured so that the first cycle wheel has a negative camber with the second cycle wheel when the first attachment assembly is coupled to the first cycle wheel in the cavity and the second attachment assembly is coupled to the second cycle wheel in the cavity.

16. The bicycle of claim 14, wherein the first end of the steerer and the second end of the steerer each have a circular opening with a center point forming a steering axis S-S, and wherein the bicycle further includes a hub axis H-H from a center of a first front bicycle wheel hub to a center of a rear bicycle wheel hub, and a normal axis N-N being perpendicular to the hub axis H-H, wherein the normal axis N-N and the steering axis S-S intersect to create an acute angle, and wherein the hub axis H-H intersects the steering axis S-S to create an obtuse angle.

17. The bicycle of claim 16, wherein the acute angle is in a range from 2 to 6 degrees and the obtuse angle is in a range from 92 to 96 degrees.

18. The bicycle of claim 14, further comprising a control bar assembly centrally mounted on the front fork and configured to couple to the first cycle wheel and the second cycle wheel, wherein movement of the control bar assembly affects a camber angle of the bicycle.

19. The bicycle of claim 18, the control bar assembly comprising a first control bar arm and a second control bar arm, wherein a first end of the first control bar arm and a first end of the second control bar arm are pivotally attached centrally to the crown of the front fork.

20. The bicycle of claim 19, wherein the first control bar arm extends outwardly left of the front fork and the first attachment assembly is adapted to attach to a second end of the first control bar, wherein the second control bar arm extends outwardly right of the front fork and the second attachment assembly is adapted to attach to the second end of the first control bar, and wherein the second end of the first control bar is coupled to the first cycle wheel and the second end of the second control bar arm is coupled to the second cycle wheel.
